(19) United States
(12) Patent Application Publication
(10) Pub. No.: US 2014/0007745 A1
(43) Pub. Date: Jan. 9, 2014

(54) WRENCH

(71) Applicant: Chih-Hung Wu, Taichung City (TW)

(72) Inventor: Chih-Hung Wu, Taichung City (TW)

(21) Appl. No.: 13/543,702

(22) Filed: Jul. 6, 2012

(51) Int. Cl. B25B 13/46

(52) U.S. Cl. 81/179

(57) ABSTRACT

A wrench for gripping a rotary fastener, includes: a main body including a handle and a C-shaped head portion that is formed with parallel first and second holes; a first gripping element being resiliently movable in the first hole; and a second gripping element being resiliently movable in the second hole. When the main body is rotated clockwise, the rotary fastener is clamped between the first and second gripping elements and is rotated together with the main body. When the main body is rotated counterclockwise, the first and second gripping elements are moved resiliently by the rotary fastener to be separated from the rotary fastener.

### BACKGROUND OF THE INVENTION

1. Field of the Invention

The invention relates to a wrench, more particularly to an open-end wrench that is convenient to use.

2. Description of the Related Art

Conventionally, the open-end wrench has an elongated handle and two C-shaped head portions connected to opposite ends of the handle. Each of the head portions has specific dimensions for gripping a fastener (e.g., a bolt) that correspond in dimensions to the head portion. Since fastening and loosening of the fastener generally requires several turns of the fastener, in a scenario where a user may operate the wrench with only one hand, the user may have to remove the wrench from the fastener for each turn.

The ratchet wrench was developed to eliminate the need of removing the wrench from the fastener for each turn. It has a ratcheting mechanism that, when turned using a rotational back-and-forth motion, turns the fastener in only one rotational direction. However, since the ratchet wrench generally has a socket head portion, the engagement between the socket head portion and the fastener by registering the head portion with the fastener and sleeving the head portion on the fastener is more inconvenient than that between an open-end wrench and the fastener by engaging the open-end wrench and the fastener via an opening in the C-shaped head portion.

### SUMMARY OF THE INVENTION

Therefore, the object of the present invention is to provide an open-end wrench having an one-way rotation mechanism relative to a rotary fastener engaged therewith.

Accordingly, a wrench for gripping a rotary fastener, comprises:

a main body including
a handle, and
a C-shaped head portion that is connected to one end of the handle, and that has a pair of jaws defining a gripping space therebetween and formed respectively with parallel first and second holes that extend obliquely with respect to the handle, the first hole having a first opening that is in spatial communication with the gripping space and extending from the first opening in a first oblique direction, the second hole having a second opening in spatial communication with the gripping space and extending from the second opening in a second oblique direction opposite to the first oblique direction;

a first gripping unit including a first gripping element that is disposed in the first hole, and that has a first gripping portion extending into the gripping space, the first gripping element being movable from a engaged state to a disengaged state along the first hole in a direction away from the first opening; and

a second gripping unit including a second gripping element that is disposed in the second hole, and that has a second gripping portion extending into the gripping space, the second gripping element being movable from a engaged state to a disengaged state along the second hole in a direction away from the second opening;

wherein, when the main body is rotated in a first rotational direction, the rotary fastener is clamped between the first gripping portion of the first gripping element and the second gripping portion of the second gripping element, and is rotated together with the main body; and

wherein, when the main body is rotated in a second rotational direction opposite to the first rotational direction, the first and second gripping elements are moved by the rotary fastener to move from the engaged states to the disengaged states for being separated from the rotary fastener.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a wrench according to the present invention;

FIG. 2 is a fragmentary exploded partly sectional view of the preferred embodiment;

FIG. 3 is a fragmentary partly sectional view of the preferred embodiment;

FIG. 4 is a sectional view of the preferred embodiment taken along line IV-IV in FIG. 3;

FIG. 5 is a sectional view of the preferred embodiment taken along line V-V in FIG. 3;

FIG. 6 is a fragmentary sectional view of the preferred embodiment, illustrating a rotary fastener gripped between a first gripping structure and a second gripping portion of the preferred embodiment and co-rotatable clockwise with the preferred embodiment;

FIG. 7 is a fragmentary sectional view of the preferred embodiment, illustrating that the preferred embodiment rotates counterclockwise relative to the rotary fastener; and

FIG. 8 is a fragmentary sectional view of the preferred embodiment, illustrating another rotary fastener gripped between a second gripping structure and the second gripping portion of the preferred embodiment and co-rotatable with the preferred embodiment.

### DETAILED DESCRIPTION OF THE PREFERRED EMBODIMENT

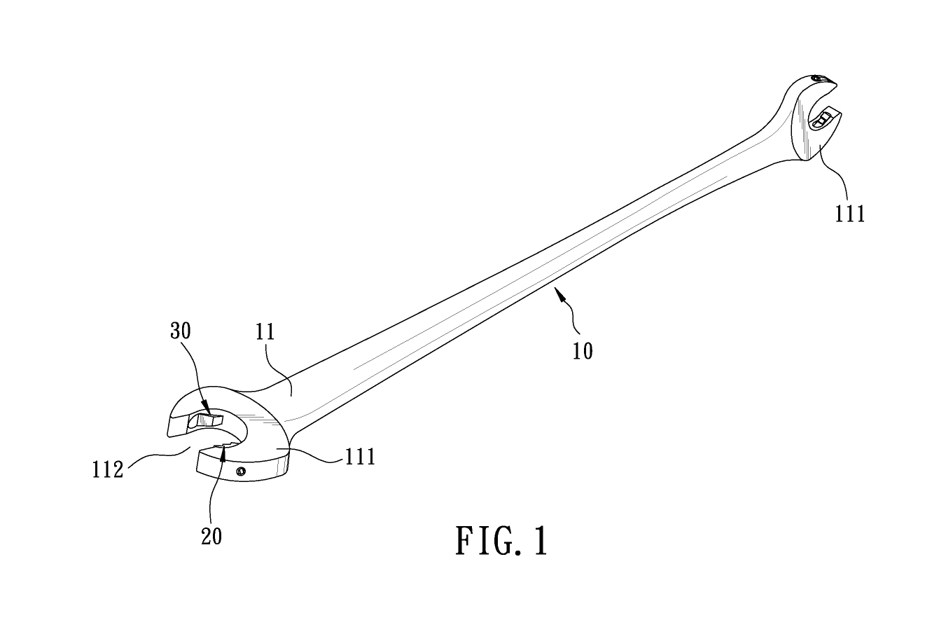

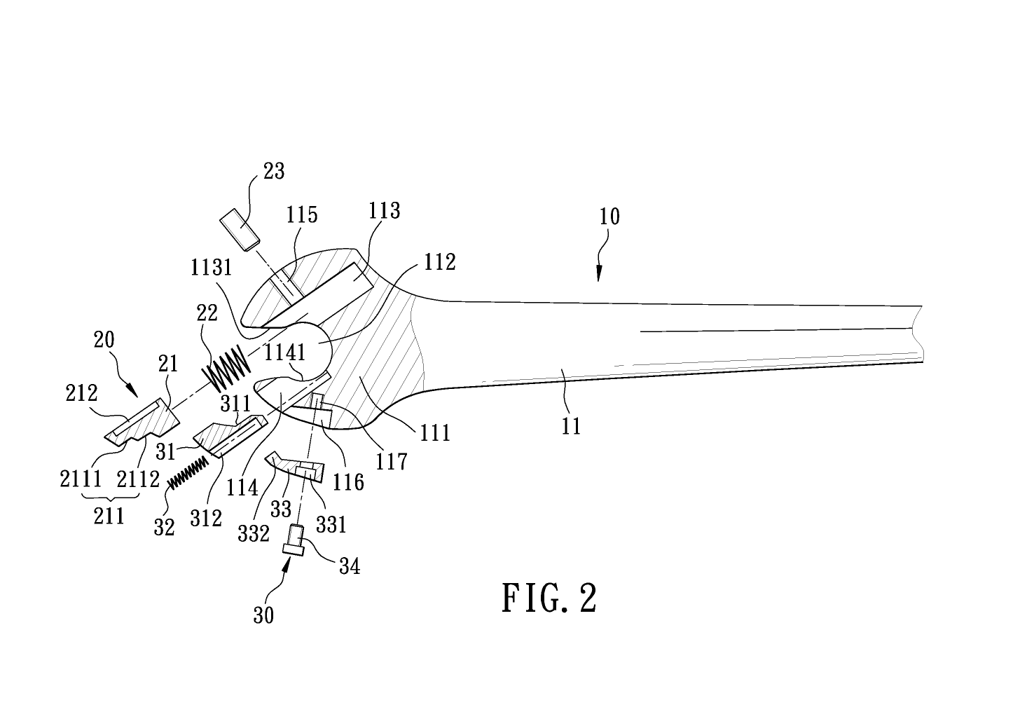

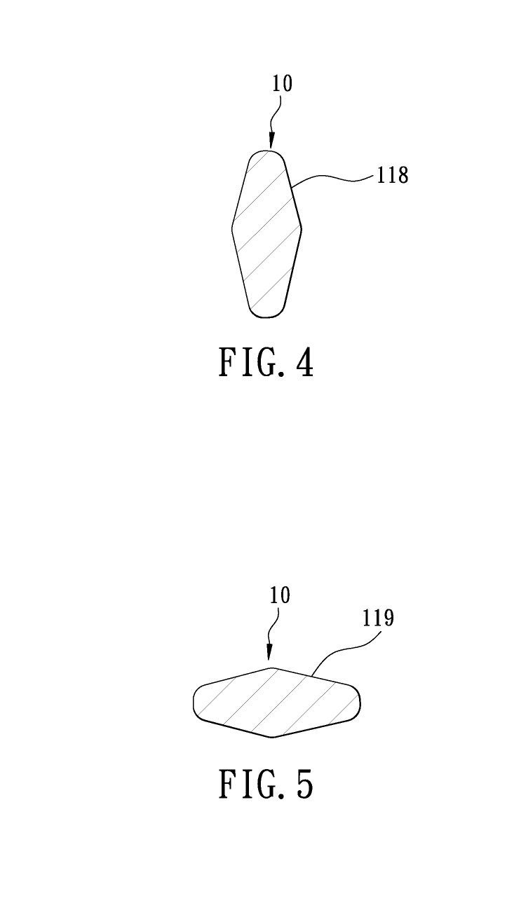

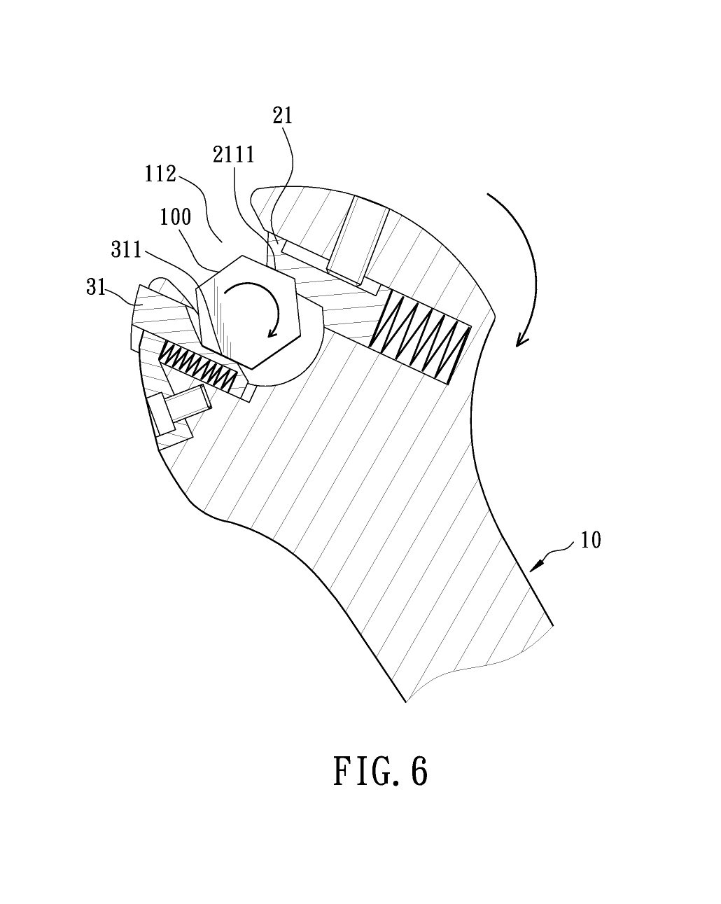

As shown in FIGS. 1, 2 and 3, the preferred embodiment of a wrench according to the present invention is for turning a rotary fastener 100, such as a bolt (see FIG. 6), and comprises a main body 10 including an elongated handle 11 and two C-shaped head portions 111 that are connected respectively to opposite ends of the handle 11. In this embodiment, the handle 11 has two handle portions 118, 119 adjacent to the head portions 111, respectively. As shown in FIGS. 4 and 5, each of the handle portions 118, 119 has a flattened cross-section. The cross-section of one of the handle portions 118, 119 is perpendicular to that of the other of the handle portions 118, 119 when viewed from a longitudinal direction of the main body 10, the design of which facilitates application of torque force onto one of the handle portions 118, 119 when the head portion 111 to which the other of the handle portions 118, 119 corresponds is engaged with the rotary fastener 100. The wrench further comprises a pair of first gripping units 20 operatively and respectively associated with the head portions 111, and a pair of second gripping units 30 operatively and respectively associated with the head portions 111. It is to be noted that, since the head portions 111 are identical in structure and function, only one of the head portions 111 will be described hereinafter for the sake of brevity.

The head portion 111 has a pair of jaws defining a gripping space 112 therebetween and formed respectively with parallel first and second holes 113, 114 that extend obliquely with respect to the handle 11. The first hole 113 has a first opening 1131 that is in spatial communication with the gripping space 112 and extends from the first opening 1131 in a first oblique direction. The second hole 114 has a second opening 1141 in spatial communication with the gripping space 112 and extends from the second opening 1141 in a second oblique direction opposite to the first oblique direction.

The first gripping unit 20 includes a first gripping element 21, a first resilient member 22, and a first restricting member 23. The first gripping element 21 is disposed in the first hole 113, and has a first gripping portion 211 extending into the gripping space 112. The first resilient member 22 is disposed in the first hole 113 for resiliently pushing the first gripping element 21. The head portion 111 is further formed with a threaded hole 115 that is in spatial communication with the first hole 113. The first gripping element 21 is formed with a groove 212 corresponding in position to the threaded hole 115. The first restricting member 23, which is configured as a threaded component, is threadedly engaged with the threaded hole 115, and has one end extending into the groove 212.

The second gripping unit 30 includes a second gripping element 31, a second resilient member 32, a second restricting member 33, and a locking member 34. The second gripping element 31 is disposed in the second hole 114, and has a second gripping portion 311 extending into the gripping space 112. The second resilient member 32 is disposed in the second gripping element 31 resiliently pushing the second gripping element 31. The head portion 111 is further formed with a restricting groove 116 that is in spatial communication with the second hole 114, and a threaded hole 117 that extends from the restricting groove 116. The second gripping element 31 is formed with a groove 312 corresponding in position to the restricting groove 116. The second restricting member 33 is disposed in the restricting groove 116, is formed with a through hole 331 corresponding in position to the threaded hole 117, and has one end 332 extending into the groove 312. The locking member 34 is extended through the through hole 331 to threadedly engage the threaded hole 117 for securing the second restricting member 33 in the restricting groove 116 of the head portion 111.

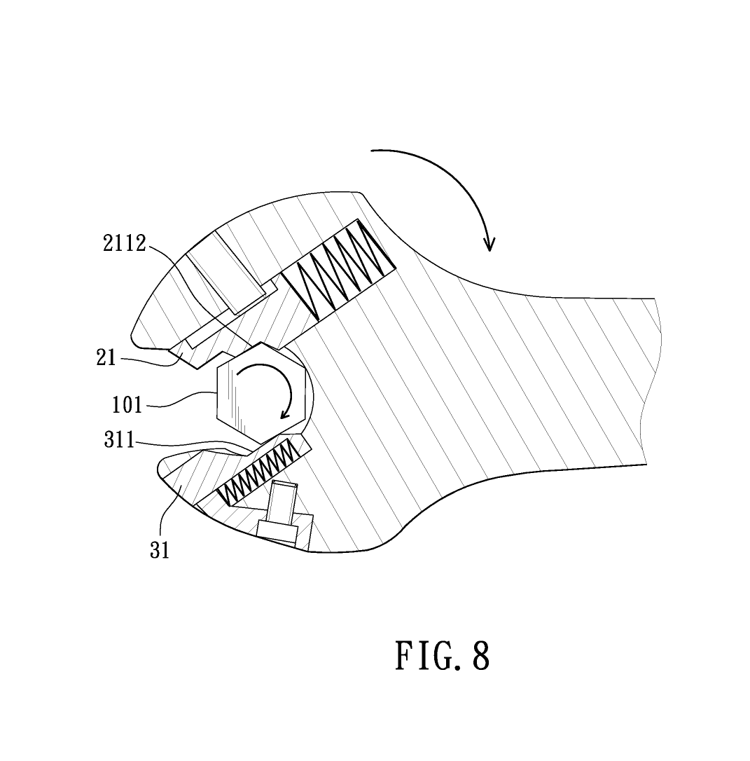

The first gripping portion 211 of the first gripping element 21 has stepped first and second gripping structures 2111, 2112 that are spaced apart from the second gripping portion 311 of the second gripping element 31 by respective, different distances for engaging rotary fasteners of different sizes (see rotary fasteners 100, 101 illustrated respectively in FIGS. 6 and 8).

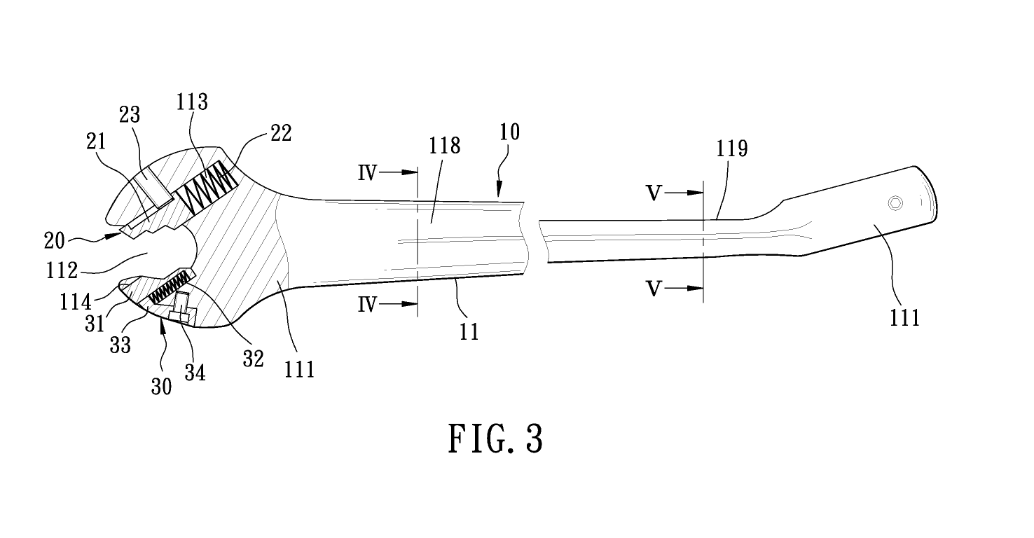

In use, when the first gripping structure 2111 of the first gripping portion 211 and the second gripping portion 311 of the second gripping element 31 grip respectively an opposite pair of surfaces of a head portion of a rotary fastener 100, the rotary fastener 100 bias the first and second gripping element 21, 31 from an initial state (see FIG. 3) to a engaged state (see FIG. 6), and the main body 10 may be turned clockwise with the rotary fastener 100.

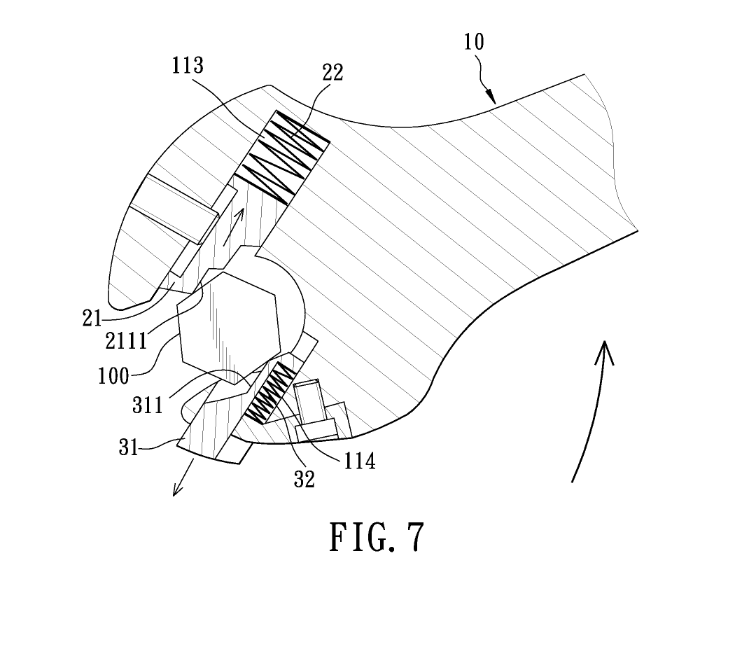

When the main body 10 is turned counterclockwise (see FIG. 7), the first and second gripping elements 21, 31 are pushed against the head portion of the rotary fastener 100, causing the first and second gripping elements 21, 31 to respectively move into the first and second holes 113, 114 from the engaged state to the disengaged state, where the first and second resilient members 22, 32 are further compressed and where the main body 10 is disengaged from the rotary fastener 100. In the disengaged state, the main body 10 is free to rotate with respect to the rotary fastener 100 until the first gripping structure 2111 and the second gripping portion 311, under bias of the respective resilient forces of the first and second resilient members 22, 32, engage respectively another opposite pair of the surfaces of the head portion of the rotary fastener 100. Subsequently, the main body 10 may again be rotated clockwise with the rotary fastener 100. After the fastening or loosening process of the rotary fastener 100 is completed and the head portion 111 is removed from the rotary fastener 100, the first and second restricting member 23, 33 can prevent the first and second gripping elements 21, 31 from falling off from the first and second holes 113, 114 when being biased by the first and second resilient members 22, 32 from the engaged states to the initial states.

In summary, the wrench of the present invention eliminates the need of being removed away from the rotary fastener 100, 101 for each turn, and may be engaged with the rotary fastener 100, 101 in the same manner as with a conventional open-end wrench.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wrench for gripping a rotary fastener, comprising:
a main body including
a handle, and
a C-shaped head portion that is connected to one end of said handle, and that has a pair of jaws which define a gripping space therebetween, and which are formed respectively with first and second holes that are parallel with respect to each other and that extend obliquely with respect to said handle, said first hole having a first opening that is in spatial communication with said gripping space and extending from said first opening in a first oblique direction, said second hole having a second opening in spatial communication with said gripping space and extending from said second opening in a second oblique direction opposite to the first oblique direction;
a first gripping unit including a first gripping element that is disposed in said first hole and that has a first gripping portion extending into said gripping space, said first gripping element being movable from a engaged state to a disengaged state along said first hole in a direction away from said first opening; and
a second gripping unit including a second gripping element that is disposed in said second hole and that has a second gripping portion extending into said gripping space, said second gripping element being movable from a engaged state to a disengaged state along said second hole in a direction away from said second opening;
wherein, when said main body is rotated in a first rotational direction, the rotary fastener is clamped between said first gripping portion of said first gripping element and said second gripping portion of said second gripping element, and is rotated together with said main body; and
wherein, when said main body is rotated in a second rotational direction opposite to the first rotational direction, said first and second gripping elements are moved by the rotary fastener to move from the engaged states to the disengaged states for being separated from the rotary fastener.

2. The wrench as claimed in claim 1, wherein said first gripping unit further includes
a first resilient member that is disposed in said first hole for resiliently pushing said first gripping element in the second oblique direction.

3. The wrench as claimed in claim 1, wherein said second gripping unit further includes
a second resilient member that is disposed in said second hole and that pushes resiliently said second gripping element in the first oblique direction

4. The wrench as claimed in claim 1, wherein said first gripping portion of said first gripping element has stepped first and second gripping structures that are spaced apart from said second gripping portion of said second gripping element by different distances for accommodating rotary fasteners with different sizes.
